(19) United States
(12) Patent Application Publication
(10) Pub. No.: US 2005/0194759 A1
(43) Pub. Date: Sep. 8, 2005

(54) Accelerating device for a scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/790,817

(22) Filed: Mar. 3, 2004

(51) Int. Cl. B62M 1/00

(52) U.S. Cl. 280/221; 280/254

(57) ABSTRACT

An accelerating device for a scooter includes a platform, a pedal, an elastic member, a sector gear, a transmission gear, a shaft, a one-way ratchet gear set, an accelerating gear set, and a rear wheel. The rear end of the platform is secured with the elastic member and one end of the pedal. The pedal has an extension board from one end to secure with the sector gear. The sector gear meshes with the transmission gear, which is then pivoted with the shaft. The transmission gear links with the ratchet gear set, which then links with the accelerating gear set and the rear wheel, thus, when stepping on the pedal, the sector gear activates the transmission gear, the ratchet gear set, the accelerating gear set, and the rear wheel subsequently.

### FIELD OF THE INVENTION

This invention relates to an accelerating device for a scooter, and more particularly to an accelerating device that can accelerate the speed without the necessity of continuously pushing the ground by a user.

### BACKGROUND OF THE INVENTION

There are a number of scooters on the market. In order to push the scooter to move forward, a user has to step the ground with one foot to push the scooter and to continuously push the ground when the speed slows down. These steps make the user bored and uncomfortable, in particular when the ride has to go through a watery area.

In view of this, the inventor has derived the present invention, which makes a great improvement on the above-mentioned shortcomings.

### SUMMARY OF THE INVENTION

It is the primary object of the present invention to provide an accelerating device for a scooter, which is easy to operate.

It is another object of the present invention to provide an accelerating device for a scooter, which design is more attractive and more secure.

It is a further object of the present invention to provide an accelerating device for a scooter, which is inexpensive to manufacture.

### BRIEF DESCRIPTION OF THE DRAWINGS

FIG. 1 is a side view of a scooter incorporated with the present invention;

FIG. 2 is a top view of the present invention;

FIG. 3 is an enlarged side view of a ratchet gear set of the present invention;

FIG. 4 is an enlarged side view of an accelerating gear set of the present invention;

FIG. 5 is an enlarged side view of a second embodiment of an accelerating gear set of the present invention; and

FIG. 6 is a side view showing an operation of the present invention.

### DETAILED DESCRIPTION OF THE PREFERRED EMBODIMENT

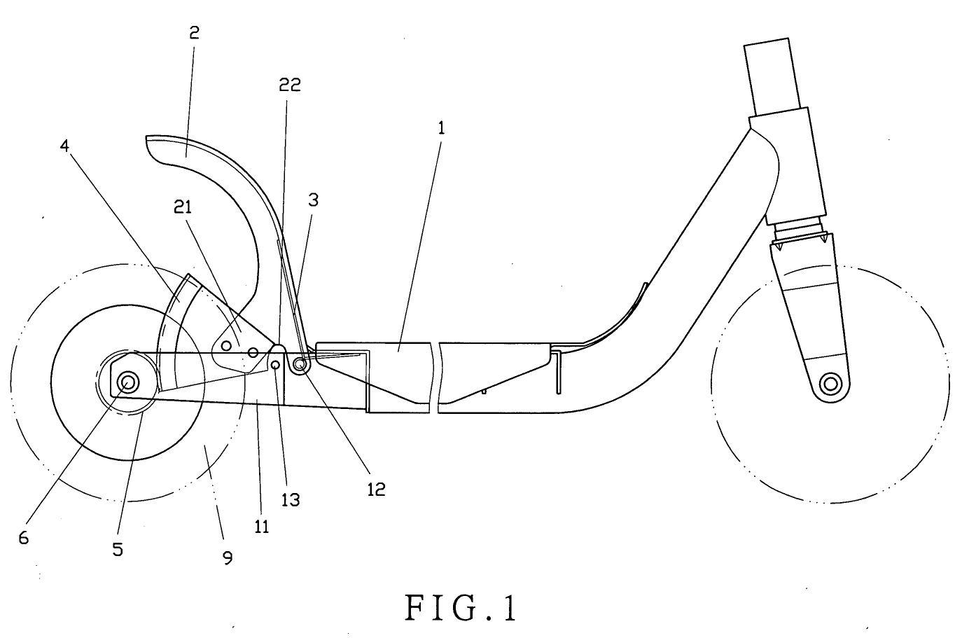

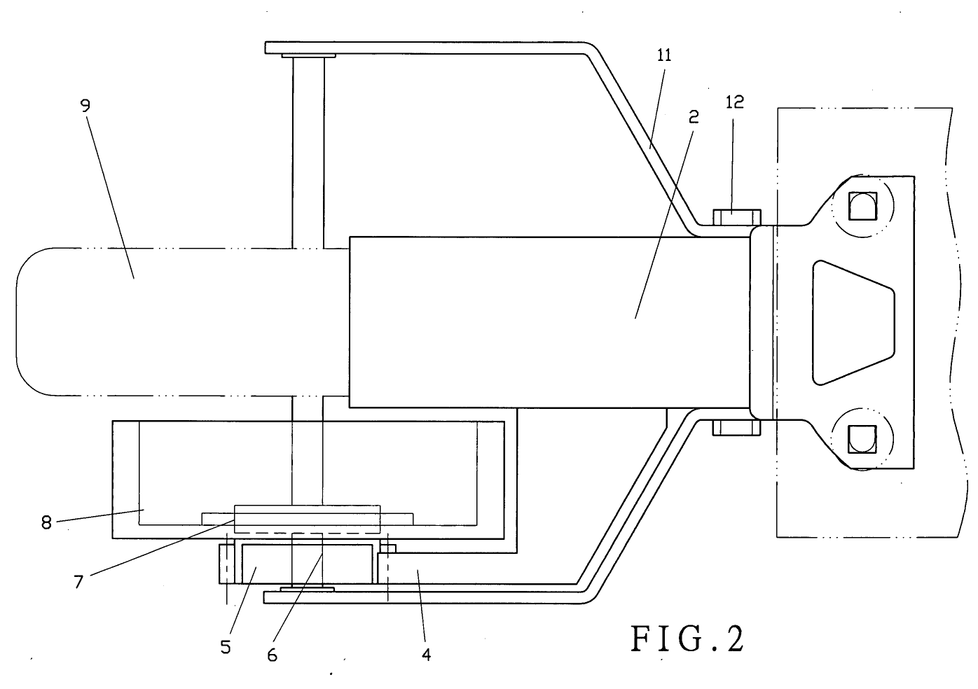

The present invention comprises a platform 1, a pedal 2, an elastic member 3, a sector gear 4, a transmission gear 5, a shaft 6, a one-way ratchet gear set 7, an accelerating gear set 8, and a rear wheel 9, as shown in FIGS. 1 and 2.

The platform 1 has pivoted the elastic member 3 and one end of the pedal 2 with a pin 12 close to the rear end thereof. A fork board 11 with a stopper 13 is formed at the rear end of the platform 1. The pedal 2 has an extension board 21 from one end to secure the sector gear 4. One side of the pedal 2 has a notch 22 in correspondence with the stopper 13. The sector gear 4 meshes with the transmission gear 5 which in turn links with the shaft 6. The arcuate shape of the pedal 2 facilitates a user to step on it and to activate the sector gear 4. Between the rear wheel 9 and the fork board 11, there is a brake formed thereat, as shown in FIG. 2, which is a traditional design and will not be described hereinafter.

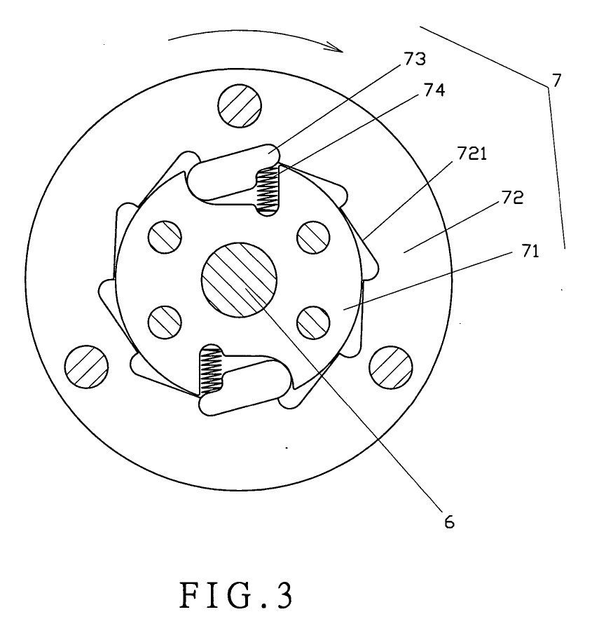

FIG. 3 shows an enlarged view of the ratchet gear set 7, which includes an inner disc 71, an outer disc 72, engaging blocks 73, and springs 74. The outer disc 72 has a ratchet-shaped recess 721. The engaging blocks 73 and springs 74 are formed between the inner disc 71 and outer disc 72, in such a manner that the springs 74 are in touch with the engaging blocks 73 towards the recess 721 of the outer disc 72, so that when the inner disc 71 spins in a clockwise direction, the engaging blocks 73 engage with the outer disc 72 and link the outer disc 72 to move simultaneously. It is however, when the inner disc 71 spins in a counterclockwise direction, the recess 721 will push the engaging blocks 73 and the springs 74 backward, thus, the outer disc 72 and the inner disc 71 are idle to spin with each other. Further, the transmission gear 5 and the inner disc 71 of the ratchet gear set 7 are secured together and linked to move together.

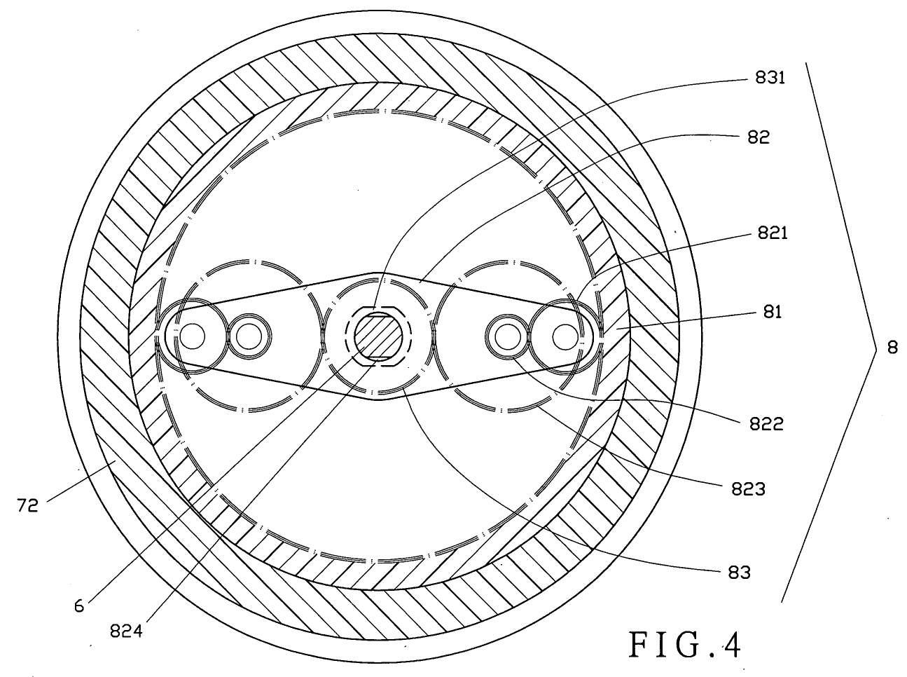

As shown in FIG. 4, the accelerating gear set 8 includes a fixed gear 81, a planetary gear set 82 and a delivery gear 83. The planetary gear set 82 comprises planetary gears 821, planetary pinions 822, and large gears 823 all fixed on a board. Each pair of the planetary pinion 822 and the large gear 823 share the same shaft. The center hole 824 of the board receives the shaft 6 therein. Both the hole 824 and the shaft 6 are in a non-round shape and have cut-off sides to match with each other when connection. The planetary gears 821 mesh with the fixed gear 81 and the planetary pinions 822. The large gears 823 mesh with the delivery gear 83 which is secured to a sleeve 831. The sleeve 831 comprises flat cut-off sides. The sleeve 831 connects with the wheel hub of the rear wheel 9. Further, the fixed gear 81 and the outer disc 72 of the ratchet gear set 7 are secured together and linked to move together. The accelerating gear set 8 has its delivery gear 83 linking with the rear wheel 9.

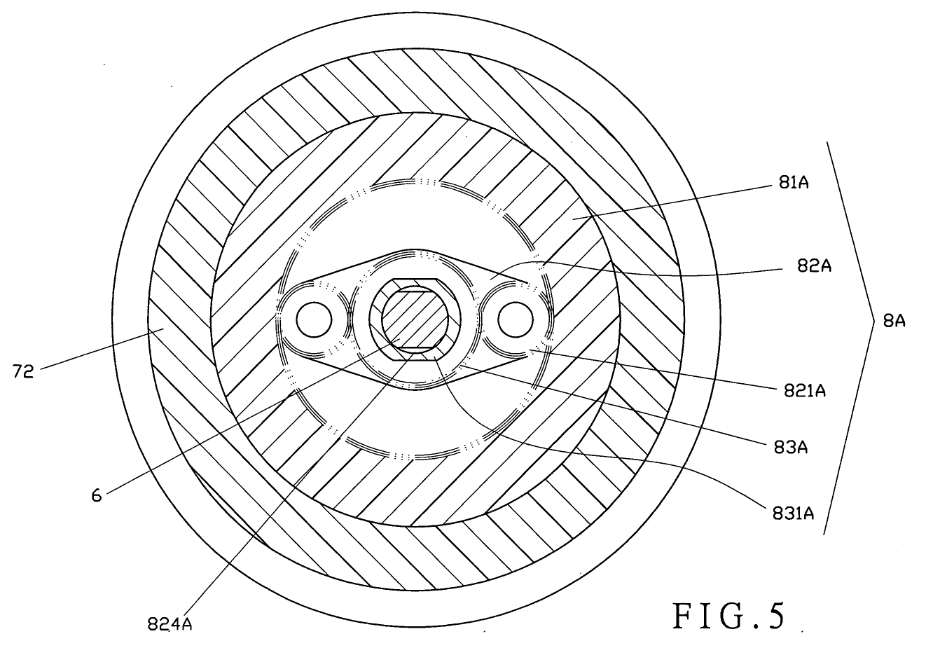

FIG. 5 shows a second embodiment of the accelerating gear set 8A, which includes a fixed gear 81A, a planetary gear set 82A, and a delivery gear 83A. The planetary gear set 82A comprises planetary gears 821A fixed on a board, a center hole 824A formed on the board of the planetary gear set 82A. The center hole 824A is in a non-round shape and has cut-off sides. The shaft 6 is inserted into the hole 824A, and is also in a non-round shape having cut-off sides corresponding to the cut-off sides of the hole 824A. The planetary gears 821A mesh with the fixed gear 81A and the delivery gear 83A. The delivery gear 83A secures with a non-round shaped sleeve 831A which then connects to the rear wheel 9. Further, the fixed gear 81A and the outer disc 72 of the ratchet gear set 7 are linked together. The outer disc 72 of the ratchet gear set 7 links the fixed gear 81A of the accelerating gear set 8A to move simultaneously, and then the delivery gear 83A of the accelerating gear set 8A links the rear wheel 9 to move.

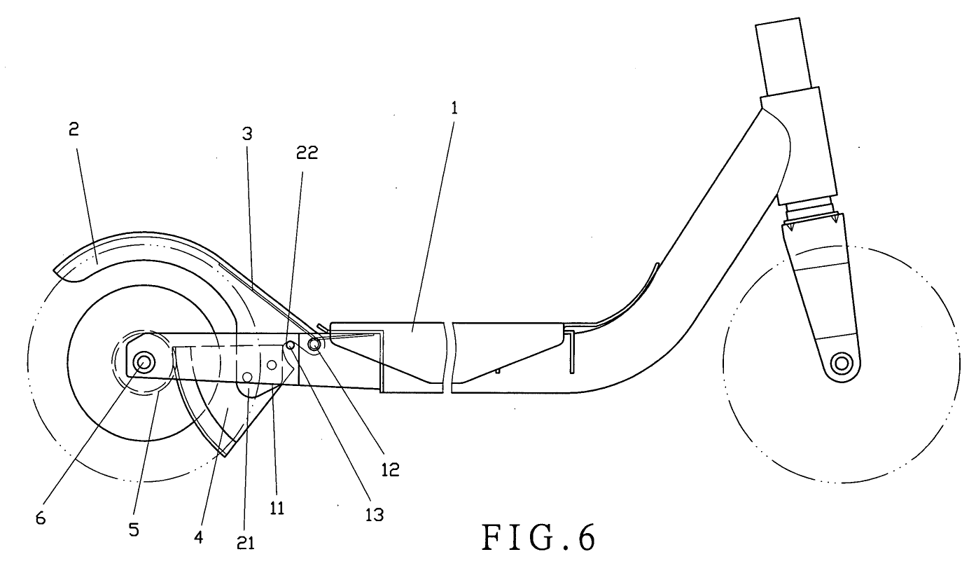

As shown in FIG. 6, when stepping the pedal 2, the sector gear 4 links the transmission gear 5 which in turn links the ratchet gear set 7, the accelerating gear set 8 and the rear wheel 9 to move. This design accelerates the speed of the scooter without the necessity of continuously pushing the ground by a user.

1. An accelerating device for a scooter comprising a platform, a pedal, an elastic member, a sector gear, a transmission gear, a shaft, a one-way ratchet gear set, an accelerating gear set, and a rear wheel, said platform being connected with said elastic member and one end of said pedal at a rear end, said pedal comprising an extension board at a rear end to secure said sector gear, said sector gear meshing with said transmission gear, said transmission gear being pivoted to said shaft, said transmission gear linking with said ratchet gear set, said ratchet gear set linking with said accelerating gear set, while said accelerating gear set linking with said rear wheel, thus, when stepping on said pedal, said sector gear linking said ratchet gear set, said accelerating gear set and said rear wheel to move through said transmission gear.

2. The accelerating device for a scooter, as recited in claim 1, wherein said pedal is in an arcuate shape.

3. The accelerating device for a scooter, as recited in claim 1, wherein said ratchet gear set comprises an inner disc, an outer disc, engaging blocks and springs, said outer disc comprising a ratchet-shaped recess, said engaging blocks and said springs being placed between said inner disc and said outer disc, said springs being in touch with said engaging blocks towards said recess of said outer disc in such a manner that upon said inner disc spinning in a clockwise direction, said engaging blocks engaging with said outer disc and linking said outer disc to move, upon said inner disc spinning in a counterclockwise direction, said recess pushing said engaging blocks backward and urging said springs, which allows said outer disc and said inner disc being idle to spin with each other, and said transmission gear and said inner disc of said ratchet gear set being secured together and linked to move together.

4. The accelerating device for a scooter, as recited in claim 1, wherein said accelerating gear set comprises a fixed gear, a planetary gear set and a delivery gear, said planetary gear set having a board pivoted with planetary gears, planetary pinions and large gears thereon, each pair of said planetary pinion and said large gear sharing a same shaft on said board, said planetary gears meshing with said fixed gear and said planetary pinions, said large gears meshing with said delivery gear, said delivery gear having a sleeve linked with said rear wheel, and said fixed gear linking with said outer disc of said ratchet gear set.

5. The accelerating device for a scooter, as recited in claim 1, wherein said accelerating gear set comprises a fixed gear, a planetary gear set, and a delivery gear, said planetary gear set having a board pivoted with planetary gears thereon, said planetary gears meshing with said fixed gear and said delivery gear, said delivery gear having a sleeve linked with said rear wheel, and said fixed gear linking with said outer disc of said ratchet gear set.
